(19) United States
(12) Patent Application Publication
(10) Pub. No.: US 2016/0019506 A1
(43) Pub. Date: Jan. 21, 2016

(54) Devices and Methods for Calendar Event Creation

(71) Applicant: Motorola Mobility LLC, Chicago, IL (US)

(72) Inventors: Abhijith Krishnappa, Bangalore (IN); Karthik K., Bangalore (IN)

(21) Appl. No.: 14/335,133

(22) Filed: Jul. 18, 2014

(51) Int. Cl. G06Q 10/10; G06Q 10/06

(52) U.S. Cl. CPC G06Q 10/1095; G06Q 10/063118

(57) ABSTRACT

A communication device (100) can include a user interface (105), a communication circuit (106), and one or more processors (103) operable with the user interface and the communication circuit. One or more memory devices (109) can store one or more applications operable on the one or more processors. The one or more processors can receive, with the user interface, a calendaring event request (802) for an event and one or more organizational policies (204) defining one or more predefined rules (401,402,403) in accordance with which multi-party events are to be scheduled. The one or more processors can automatically fragment the event into two or more separate sub-events (1101,1102,1103,1104,1105,1106,1107,1108,1109,1110,1111) in accordance with the one or more predefined rules.

### BACKGROUND

1. Technical Field

This disclosure relates generally to electronic devices, and more particularly to electronic devices operable with calendaring applications.

2. Background Art

Mobile electronic communication devices, such as mobile telephones, smart phones, gaming devices, and the like, are used by billions of people. The owners of such devices come from all walks of life. These owners use mobile communication devices for many different purposes including, but not limited to, voice communications and data communications for text messaging, Internet browsing, commerce such as banking, and social networking. The circumstances under which users of mobile communication device use their devices varies widely as well.

Many users rely on calendaring applications operating on their personal electronic device to keep track of appointments, meetings, and personal commitments. It would be advantageous to have an improved calendaring application.

### BRIEF DESCRIPTION OF THE DRAWINGS

FIG. 1 illustrates one explanatory electronic device configured in accordance with one or more embodiments of the disclosure.

FIG. 2 illustrates one explanatory server system in accordance with one or more embodiments of the disclosure.

FIG. 3 illustrates an explanatory method in accordance with one or more embodiments of the disclosure.

FIG. 4 illustrates explanatory predefined rules in accordance with one or more embodiments of the disclosure.

FIG. 5 illustrates explanatory informational criteria upon which calendar event fragmentation may be based in accordance with one or more embodiments of the disclosure.

FIG. 6 illustrates explanatory method steps in accordance with one or more embodiments of the disclosure.

FIG. 7 illustrates explanatory method steps in accordance with one or more embodiments of the disclosure.

FIG. 8 illustrates explanatory method steps in accordance with one or more embodiments of the disclosure.

FIG. 9 illustrates explanatory method steps in accordance with one or more embodiments of the disclosure.

FIG. 10 illustrates explanatory method steps in accordance with one or more embodiments of the disclosure.

FIG. 11 illustrates explanatory method steps in accordance with one or more embodiments of the disclosure.

FIG. 12 illustrates explanatory method steps in accordance with one or more embodiments of the disclosure.

FIG. 13 explanatory method steps in accordance with one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to automatic fragmentation of calendar events in an electronic device. Any process descriptions or blocks in flow charts should be understood as representing modules, segments, or portions of code that include one or more executable instructions for implementing specific logical functions or steps in the process. Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

It will be appreciated that embodiments of the disclosure described herein may be comprised of one or more conventional processors and unique stored program instructions that control the one or more processors to implement, in conjunction with certain non-processor circuits, some, most, or all of the functions automatic calendar event fragmentation by an electronic device or system as described herein. The non-processor circuits may include, but are not limited to, a radio receiver, a radio transmitter, signal drivers, clock circuits, power source circuits, and user input devices. As such, these functions may be interpreted as steps of a method to perform selective fragmentation of one or more calendar events in a particular electronic device. Alternatively, some or all functions could be implemented by a state machine that has no stored program instructions, or in one or more application specific integrated circuits (ASICs), in which each function or some combinations of certain functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Embodiments of the disclosure provide improvements for calendaring applications operating on an electronic device. Embodiments of the disclosure contemplate that businesses, companies, organizations, academic institutions, governmental agencies, social networks, groups of friends, and so forth will have policies that govern meetings and group events. Illustrating by example, a business may have a mandated lunch hour from 1:30 PM to 2:00 PM. That same business may have a mandatory rule that no meeting can occur for more than ninety minutes without including a fifteen-minute break. Embodiments of the disclosure contemplate that it can be difficult for a person trying to schedule a meeting with a calendaring application to manually contemplate each of these organizational policies. This is especially true when the meeting scheduler must navigate attendee conflicts as well.

Accordingly, embodiments of the disclosure provide a calendaring application that automatically fragments calendaring events as a function of one or more predefined rules defining one or more organizational policies. Using the example above, if the meeting scheduler scheduled a three-hour meeting beginning at 11:00 AM, embodiments of the disclosure would automatically fragment that event into three sub-events. The three sub-events would be separated by the company's mandatory lunch break from 1:30 PM to 2:00 PM, as well as by a mandated fifteen-minute break. The first sub-part of the meeting, after automatic fragmentation, might thus run from 11:00 AM to 12:00 PM, with a fifteen-minute break from 12:00 PM to 12:15 PM. A second sub-part of the meeting might then run from 12:15 PM to 1:30 PM, with a lunch break from 1:30 PM to 2:00 PM. The final sub-part might then run from 2:00 PM to 3:15 PM, thus providing three sub-parts totaling three hours total. In one embodiment, the only information the meeting organizer must input to obtain this fragmentation is the start time, duration, and attendee list. Embodiments of the disclosure do the rest. In one or more embodiments, alarm reminders for each sub-part can be automatically included as well. While multi-party events are one type of event suitable for use with embodiments of the disclosure, it should be noted that individual events could be automatically fragmented in accordance with organizational policies as well.

In one embodiment, a user desiring to create a calendar event enters a preferred start time and an event duration. Embodiments of the disclosure then fragment the calendar event into sub-events, with each sub-event providing an indication of the micro-level details regarding that sub-event. In one embodiment, the calendar event is automatically fragmented and extended based upon a set of organizational policies. Of course, overlapping organization events or conflicting attendee events can be considered in the automatic fragmentation of the calendar event as well. Other factors suitable as a basis for the fragmentation will be described below. Still others will be obvious to those of ordinary skill in the art having the benefit of this disclosure.

In one embodiment, factors that can be considered in a calendar event fragmentation function include intervals, organizational policies, and overlapping events of the owner and/or calendar event attendees. The organizational policies can include one or more predefined rules in accordance with which multi-party or single-party events are to be scheduled within an organization or other social structure. In one embodiment, the event creator can review the fragmented calendar event for editing or modification as well.

To illustrate with another simple use case, presume a user wishes to create a four-hour meeting with a preferred start time of noon. Next presume that the interval considerations, organizational policy considerations, and overlapping event considerations are as follows: First, the organization mandates that lunch shall be between 1:30 PM and 2:00 PM. Second, the organization mandates that no meeting shall exceed two hours. Third, the organization mandates that any meeting exceeding two hours shall have a fifteen-minute break. Fourth, the organization mandates that the meeting organizer include reminders before the start of any meeting event. Fifth, presume one of the attendees has a conflict between the hours of 2:00 PM and 3:00 PM.

In one embodiment, one or more processors of an electronic device are to receive, through a user interface, a calendaring event request. In one embodiment, the request comprises only the requested start time, i.e., 12:00 PM, the duration, i.e., four hours, and one or more third parties, i.e., the attendees. The electronic device then receives, with a communication circuit of the electronic device, one or more organizational policies defining the first four considerations above. The electronic device then receives, with the communication circuit, one or more conflicting events scheduled by the attendees, i.e., the fifth consideration above.

In one embodiment, one or more processors of the electronic device then import these considerations. The one or more processors then exercise one or more algorithms to provide, automatically, on a user interface of the electronic device, and to the event creator, a single calendar event which is fragmented into sub-events and extended to accommodate the four hours of requested meeting time about the mandated breaks and guidelines. Advantageously, the meeting creator need not create multiple calendar events for scheduling the meeting about the various policies and considerations. It is all done automatically in one or more embodiments.

In the example above, the first sub-event may be a meeting from 12:00 PM to 1:30 PM. A second sub-event may be a lunch break—added automatically—from 1:30 PM to 2:00 PM. No meeting sub-event is then scheduled between 2:00 PM and 3:00 PM due to the conflict of one of the attendees. A third sub-event may then be a meeting scheduled from 3:00 PM to 5:00 PM. A fourth sub-event may then be a break from 5:00 PM to 5:15 PM per the organizational policy mandate. A fifth sub-event may then be another meeting portion from 5:15 PM to 5:45 PM. In one embodiment, reminders shall automatically be added and displayed before the start time of every sub-event. In effect, a single calendar event can be fragmented and extended automatically in consideration of these five factors, which are explanatory only. As noted above, other considerations will be obvious to those of ordinary skill in the art having the benefit of this disclosure. As also noted above, in one or more embodiments a user is provided the opportunity to review and/or edit the fragmented calendar event anytime, as well as modify the sub-events as per convenience.

In one embodiment, when the calendar event is fragmented, the fragmented series of events is created with a common subject or title. Thus, in the example above, when displayed on the calendar of an attendee, each of the five sub-events can be created with a common title. For example, if the meeting is called “X4265 Specification Review,” each of the sub-events can include this title in its heading or subject line. This commonality of titling, advantageously, allows the user to instantly recognize the fragmented portions as relating to a common event requested by the meeting scheduler.

In one embodiment, a communication device comprises a user interface, a communication circuit, and one or more processors operable with the user interface and the communication circuit. The communication device can also include one or more memory devices to store one or more applications operable on the one or more processors. Once such application is a calendaring application.

In one embodiment, such as when executing the calendaring application, the one or more processors can be configured to receive, with the user interface, a calendaring event request for an event. In one embodiment, the event is a multi-party event. However, as noted above, the event can be for a single individual as well.

In one embodiment, the one or more processors then receive, with the communication circuit, one or more organizational policies defining one or more predefined rules in accordance with which events are to be scheduled. As noted above, the organizational policies may be those of various social structures, including but not limited to businesses, clubs, religious organizations, academic organizations, governmental organizations, social organizations, and so forth. In one embodiment, in response to receiving the calendaring event request and the organizational policies, the one or more processors can then automatically fragment the event into two or more separate sub-events in accordance with the one or more predefined rules defining the organizational policies. This advantageously removes the need for the meeting organizer to manually do the same.

In one embodiment, each sub-event can have a common title. As noted above, this can make it easy for a user to identify related events in a calendaring application. Other features can be included, such as the automatic insertion of breaks, reminders, alarms, and the like. Other features will be described in the examples below. Still others will be obvious to those of ordinary skill in the art having the benefit of this disclosure.

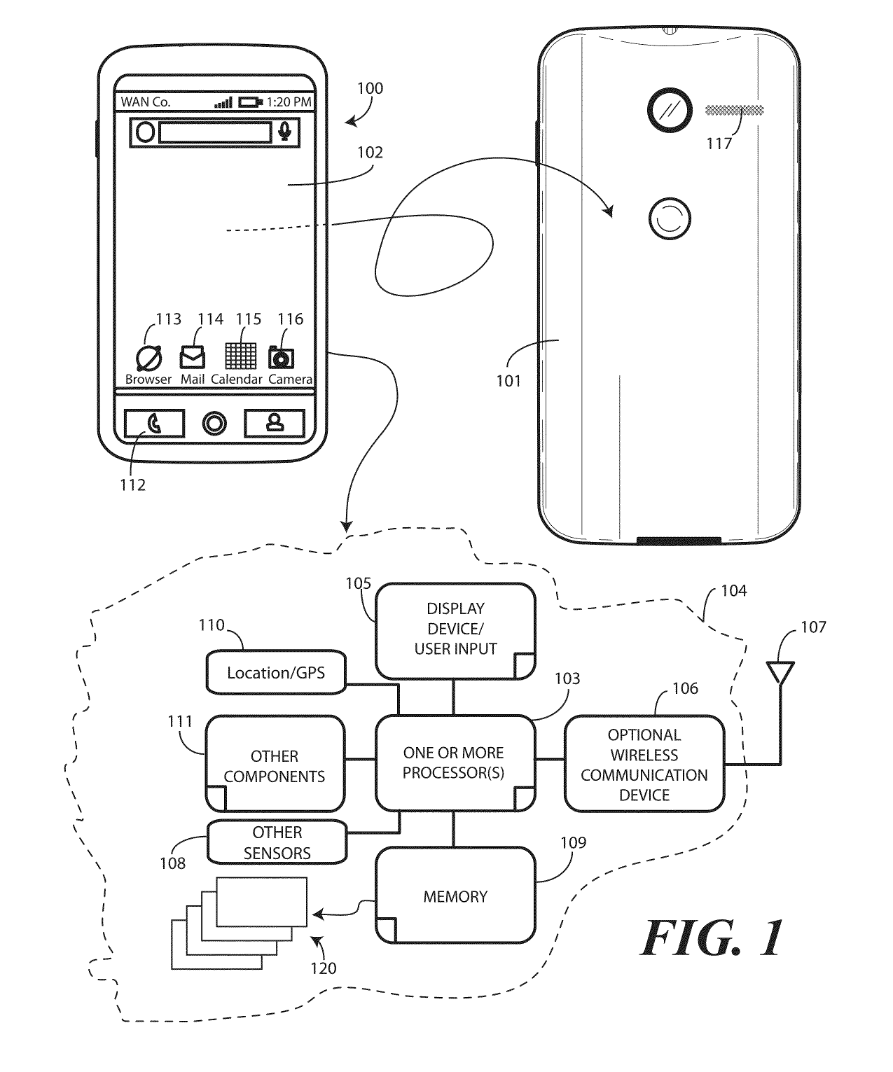

Turning now to FIG. 1, illustrated therein is one explanatory communication device 100 configured in accordance with one or more embodiments of the disclosure. The explanatory communication device 100 is shown as a smart phone for ease of illustration. However, it will be obvious to those of ordinary skill in the art having the benefit of this disclosure that other electronic communication devices—be they portable or not—may be substituted for the explanatory smart phone used below for ease of illustration. For example, the communication device 100 may be configured as a palm-top computer, a tablet computer, desktop computer, gaming device, wearable computer, a media player, laptop computer, portable computer, or other electronic device.

The communication device 100 includes a housing 101. In one embodiment, a display 102 is disposed along the front surface of the housing 101 of the communication device 100. In one embodiment, the display 102 is configured to provide visual output, images, or other visible Information to a user. In one embodiment, the display 102 comprises an organic light emitting diode (OLED) device.

In one embodiment, the display 102 comprises a touch sensor to form touch sensitive display configured to receive user input across the surface of the display 102. The display 102 can also be configured with a force sensor. Where configured with both a touch sensor and force sensor, one or more processors 103 of the communication device 100, operable with the touch sensor and the force sensor, can determine not only where the user contacts the display 102, but also how much force the user employs in contacting the display 102.

In FIG. 1, the explanatory communication device 100 is shown illustratively with a schematic block diagram 104. The schematic block diagram 104 illustrates various components and modules suitable for inclusion in the communication device 100. It will be clear to those of ordinary skill in the art having the benefit of this disclosure that the components and modules can be used in different combinations, with some components and modules included and others omitted.

In this embodiment, the communication device 100 includes a user interface 105, which can include the display 102. Alternatively, the user interface 105 can be a touch-pad, joystick, keypad, or other user interface that is disposed adjacent to the display 102. The illustrative communication device 100 also includes a communication circuit 106 that can be configured for wired or wireless communication with one or more other devices or networks. The networks can include a wide area network, such as a Code Division Multiple Access (CDMA) network, a Global System for Mobile communication (GSM) network, a Push-to-Talk (PTT) network, Dual Band Universal Mobile Telecommunications System (UMTS) networks, and direct communication networks. Alternatively, the network can be a local area network or personal area network as well. The communication circuit 106 can include wireless communication circuitry, one of a receiver, a transmitter, or transceiver, and one or more antennas 107.

The communication device 100 includes one or more processors 103, which can have one or more control circuits. The one or more processors 103 are responsible for performing the various functions of the device. The one or more processors 103 can be a microprocessor, a group of processing components, one or more Application Specific Integrated Circuits (ASICs), programmable logic, or other type of processing device. The one or more processors 103 can be operable with the user interface 105 and the communication circuit 106, as well as various sensors 108 that can be coupled to the one or more processors 103 via interface connections.

The one or more processors 103 can be configured to process and execute executable software code to perform the various functions of the communication device 100. A storage device, such as memory 109, stores the executable software code used by the one or more processors 103 for device operation. The memory 109 can optionally store one or more organizational policies that are defined by one or more predefined rules. The executable software code used by the one or more processors 103 can be configured as one or more modules 120 that are operable with the one or more processors 103. Such modules 120 can store instructions, control algorithms, and so forth. The instructions can instruct processors or one or more processors 103 to perform the various steps, emergency mode of operation, and methods described below.

One or more sensors 108 can be operable with the one or more processors 103. These sensors 108 can include, in any combination, a light sensor, an infrared sensor, a motion sensor, and optionally biometric sensors. A light sensor, where included, can detect changes in optical intensity, color, light, or shadow in the near vicinity of the communication device 100. The light sensor can be configured as an image-sensing device that captures successive images about the device and compares luminous intensity, color, or other spatial variations between images to detect motion or the presence of an object near the communication device 100. An infrared sensor can be used in conjunction with, or in place of, the light sensor. The infrared sensor can be configured to operate in a similar manner, but on the basis of infrared radiation rather than visible light.

A motion sensor can be included to detect motion of the communication device 100. In one embodiment, the motion sensor includes an accelerometer. The accelerometer can also be used to determine the spatial orientation of the communication device 100 in three-dimensional space by detecting a gravitational direction. In addition to, or instead of, the accelerometer, an electronic compass can be included to detect the spatial orientation of the communication device 100 relative to the earth's magnetic field. Similarly, one or more gyroscopes can be included to detect rotational motion of the communication device 100. The gyroscope can be used to determine the spatial rotation of the communication device 100 in three-dimensional space.

One or more biometric sensors can also be included for sensing biometric information relating to a particular user. The sensors 108 can also include an audio capture circuit operable with the one or more processors 103. The audio capture circuit can include one or more microphones to receive voice input, voice commands, and other audio input.

In one or more embodiments, a location sensor 110 is included. In one embodiment, the location sensor 110 is a global positioning system device for determining where the communication device 100 is located. The global positioning system device can be configured for communicating with a constellation of earth orbiting satellites or a network of terrestrial base stations to determine an approximate location. Examples of satellite positioning systems suitable for use with embodiments of the present invention include, among others, the Navigation System with Time and Range (NAVSTAR) Global Positioning Systems (GPS) in the United States of America, the Global Orbiting Navigation System (GLONASS) in Russia, and other similar satellite positioning systems. The satellite positioning systems based location fixes of the global positioning system device autonomously or with assistance from terrestrial base stations, for example with assistance from a cellular communication network or other ground based network, or as part of a Differential Global Positioning System (DGPS), as is well known by those having ordinary skill in the art. While a global positioning system device is one example of a location sensor, it will be clear to those of ordinary skill in the art having the benefit of this disclosure that other location determination devices, such as electronic compasses or gyroscopes, could be used as well.

In one embodiment, the one or more processors 103 are responsible for running an operating system environment of the communication device 100. The operating system environment can include a kernel, one or more drivers, and an application service layer, and an application layer. The operating system environment can be configured as executable code operating on one or more processors 103 of the communication device 100.

The application layer can be responsible for executing application service modules. The application service modules may support one or more applications or “apps.” Examples of such

[symbol]

The communication device 100 can include other components 111. The other components 111 may include a video input component such as an optical sensor, another audio input component such as a microphone, and a mechanical input component such as button or key selection sensors, touch pad sensor, touch screen sensor, capacitive sensor, motion sensor, and switch. Similarly, the other components 111 can include output components such as video, audio, and/or mechanical outputs. For example, the output components may include a video output component such as the display 102 or auxiliary devices including a cathode ray tube, liquid crystal display, plasma display, incandescent light, fluorescent light, front or rear projection display, and light emitting diode indicator. Other examples of output components include audio output components such as speaker port 117 or other alarms and/or buzzers and/or a mechanical output component such as vibrating or motion-based mechanisms. The other components 111 of the communication device 100 can also include a device interface to provide a direct connection to auxiliary components or accessories for additional or enhanced functionality and a power source, such as a portable battery, for providing power to the other internal components and allow portability of the communication device 100.

It is to be understood that the schematic 104 of FIG. 1 is provided for illustrative purposes only and for illustrating components of one communication device 100 in accordance with embodiments of the disclosure, and is not intended to be a complete schematic diagram of the various components required for an electronic device. Therefore, other electronic devices in accordance with embodiments of the disclosure may include various other components not shown in FIG. 1, or may include a combination of two or more components or a division of a particular component into two or more separate components, and still be within the scope of the present disclosure.

In one embodiment, the one or more processors 103 of the communication device 100 can be used to fragment calendar events in accordance with one or more predefined rules defining one or more organizational policies as noted above. For example, in one embodiment a user can launch the calendaring application 115. When executing the calendaring application, the one or more processors 103 can receive, with the user interface 105, a calendaring event request. In one embodiment, the calendaring event request is for a multi-party event. In another embodiment, the calendaring event request is for a single-party event.

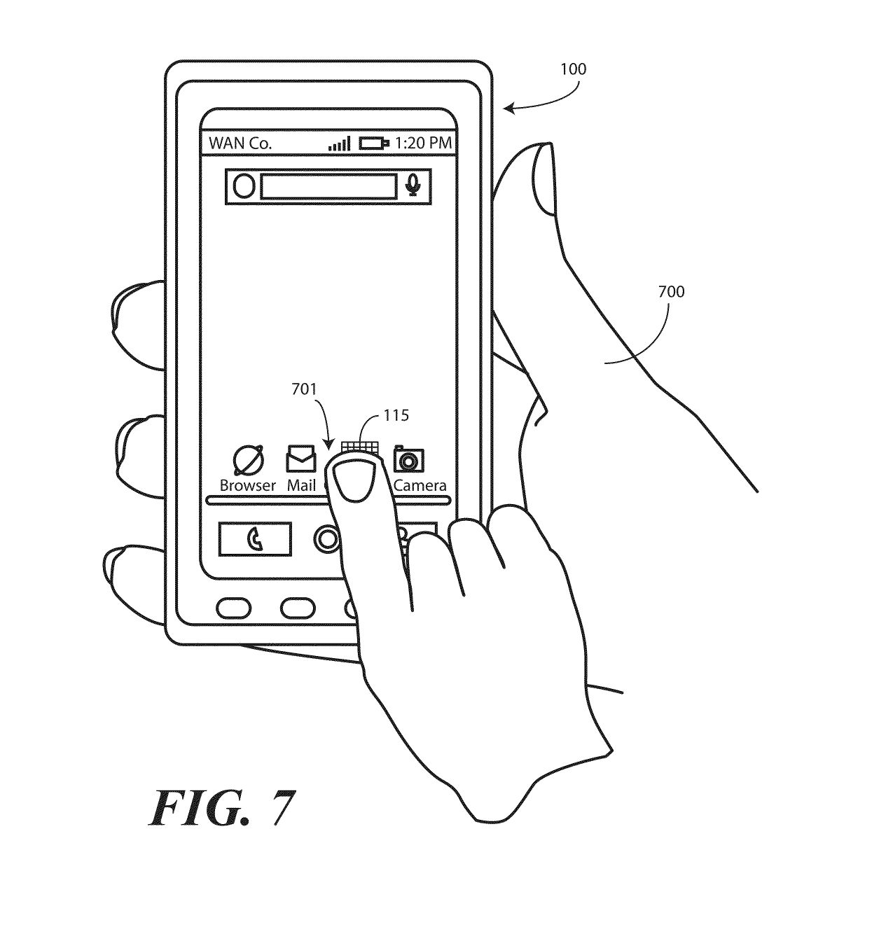

In one embodiment, the one or more processors 103 can then receive, with the communication circuit 106, one or more organizational policies defining one or more predefined rules in accordance with which events—be they multi-party or single-party—are to be scheduled. The one or more processors 103 can then, in one embodiment, automatically fragment the event into two or more separate sub-events in accordance with the one or more predefined rules as described above. Examples of this will be provided in FIGS. 7-13 below.

In one embodiment, the one or more processors 103 of the communication device 100 perform the automatic fragmentation locally on the communication device 100. However, in other embodiments the communication device 100 can be in communication with one or more servers. For example, an enterprise calendaring application may be operable on one or more servers. The communication device 100 may then serve as a user interface proxy for the one or more servers. Accordingly, the one or more processors 103 can receive, with the user interface 105, a calendaring event request. The one or more processors 103 can then send, with the communication circuit 106, the calendaring event request to one or more servers, which perform the automatic fragmentation of the calendaring event in accordance with the organizational polices that are either stored on the one or more servers or that are received by a communication device of the one or more servers. The one or more servers can then return the fragmented calendaring event to the communication device 100. The one or more processors 103 can then present the fragmented calendaring event on the user interface 105, where a user may optionally edit the fragmented calendaring event.

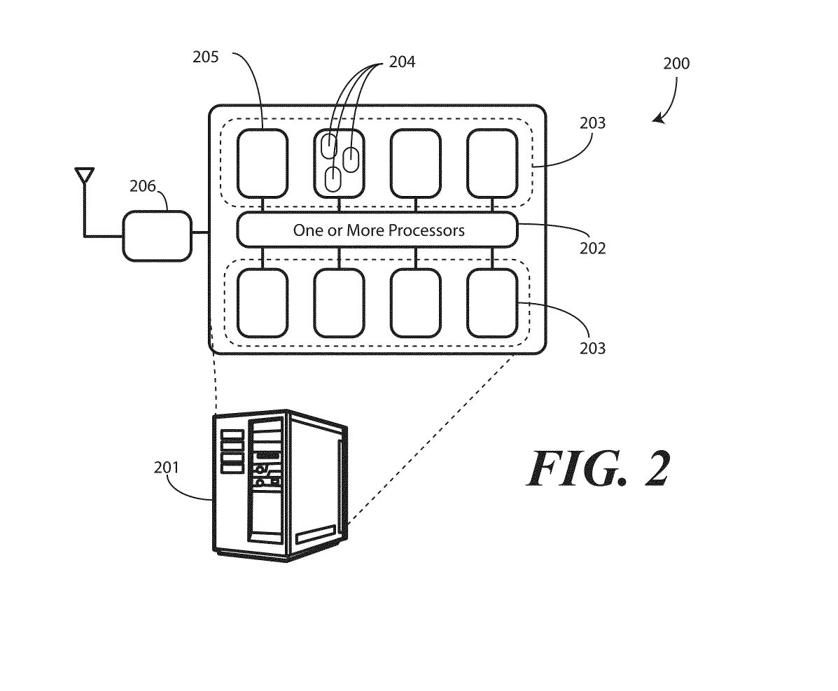

Turning now to FIG. 2, illustrated therein is one example of a server complex 200 suitable for performing the operations of the preceding paragraph in accordance with one or more embodiments of the disclosure. Server 201 is representative of one or more servers. The server 201 can include one or more processors 202. The one or more processors 202 may be operable with one or more memory devices 203. The one or more processors 202 may be operable with a communication device 206 for communication across a network. The communication can be wired, wireless, or combinations thereof.

The one or more memory devices 203 can be used to store various types of information, including organizational policies 204. Additionally, the one or more memory devices 203 can execute a calendaring application 205 as well. In one or more embodiments, the one or more processors 202 can transmit information to one or more mobile communication devices through the communication device 206. Further, the one or more processors 202 can receive, query, and optionally store in the one or more memory devices 203, information from one or more communication devices, e.g., communication device (100), through the communication device 206 of the server 201.

The server 201 can interact with the communication device (100) in one of several ways.

In one embodiment, the server 201 delivers the organizational policies 204, including any corresponding predefined rules, to the communication device (100) with the communication device 206. Accordingly, where the one or more processors (103) of the communication device (100) automatically fragment calendar event requests in the communication device (100), fragmentation of a calendar event request can be a function of the organizational policies 204. It should be noted that the organizational policies 204 can reside in the memory (109) of the communication device (100) as well so that interaction with the server 201 is not required. However, delivering the organizational policies 204 from the server 201 to the communication device (100) offers the advantage of being able to update the predefined rules defining the organizational policies 204 in a singe location to be distributed to one or more communication devices in an enterprise configuration.

In another embodiment, noted above, a calendaring application 205 can be operational on the one or more processors 202 of the server 201. The communication device (100) may then serve as a user interface proxy for the one or more servers. Accordingly, the one or more processors (103) of the communication device can receive, with the user interface (105), a calendaring event request. The one or more processors (103) can then send, with the communication circuit (106), the calendaring event request to the server 201, which receives the same through the communication device 206. The one or more processors 202 of the server 201 can then perform the automatic fragmentation of the calendaring event in accordance with the organizational policies 204 that are either stored in the one or more memory devices 203 of the server 201, or that are received by the communication device 206 of the server 201. The server 201 can then return the fragmented calendaring event to the communication device (100) for presentation on the user interface (105).

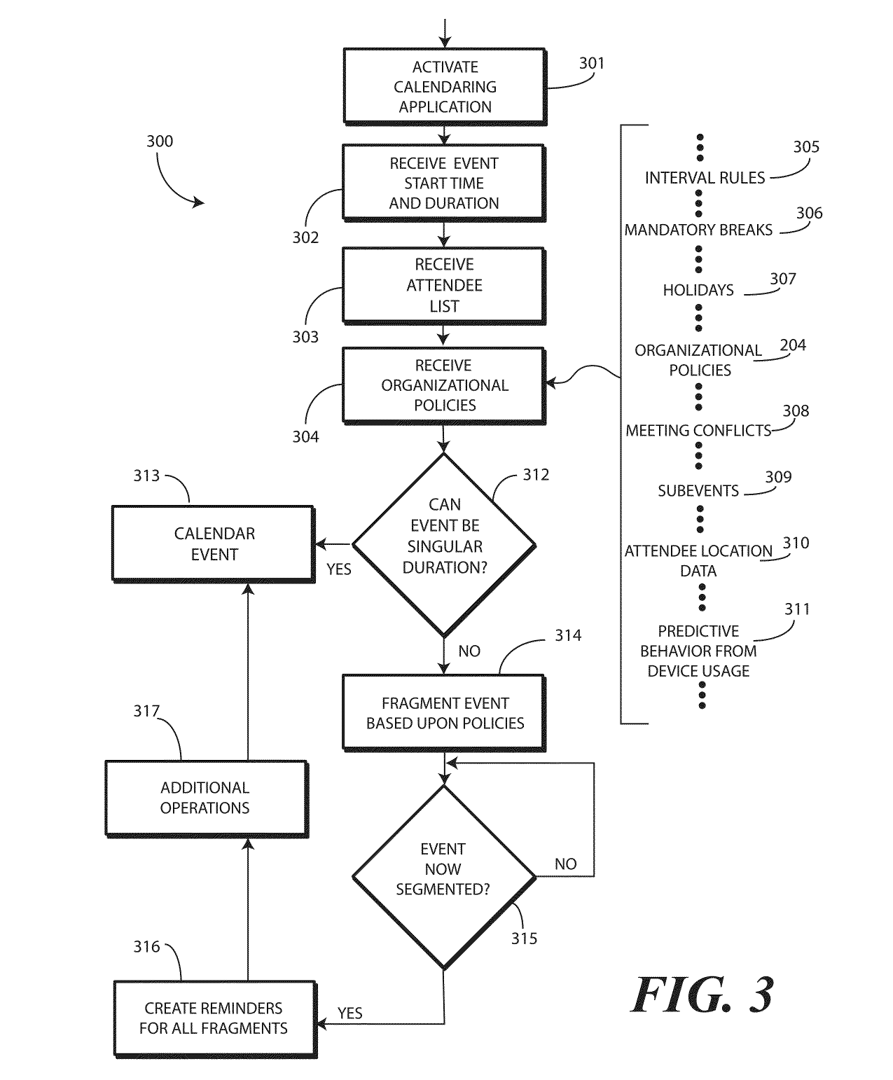

Turning now to FIG. 3, illustrated therein is one explanatory method 300 configured in accordance with one or more embodiments of the disclosure. In one embodiment, the method 300 is suitable for execution on one or more processors (103) of a communication device (100), one or more processors (202) of a server (201), or combinations thereof.

At step 301, a calendaring application is activated. In one embodiment, the calendaring application is activated on a communication device. In another embodiment, the calendaring application is activated on a server in communication with one or more communication devices. In the latter embodiment, the one or more communication devices can serve as user interface proxies for the calendaring application operating on the server.

At step 302, the method 300 receives a calendaring event request. One example of a calendaring event request used in businesses is a meeting request. In one embodiment, the calendaring event request is received via a user interface of an electronic device.

In one embodiment, to simplify operation of the method 300, step 302 includes only receiving two items: a requested start time and a calendaring event request duration. A third item, the attendee list, can be received at step 303. Thus, in one embodiment a calendaring event request includes only three items: a requested start time, received at step 302, one or more third parties, received at step 303, and a duration, received at step 302. Advantageously, organizational policies, interval rules, and other items do not have to be delivered by a user. Fragmentation as a function of these events can occur automatically in one or more embodiments.

At step 304, the method receives one or more organizational policies 204 governing meetings or other events within an organization. As noted above, step 304 can include receiving the one or more organizational policies 204 through a communication device. Alternatively, one or more processors of an electronic device can retrieve the one or more organizational policies 204 from a memory device. In one embodiment, the one or more organizational policies 204 define one or more rules in accordance with which events are to be scheduled within an organization.

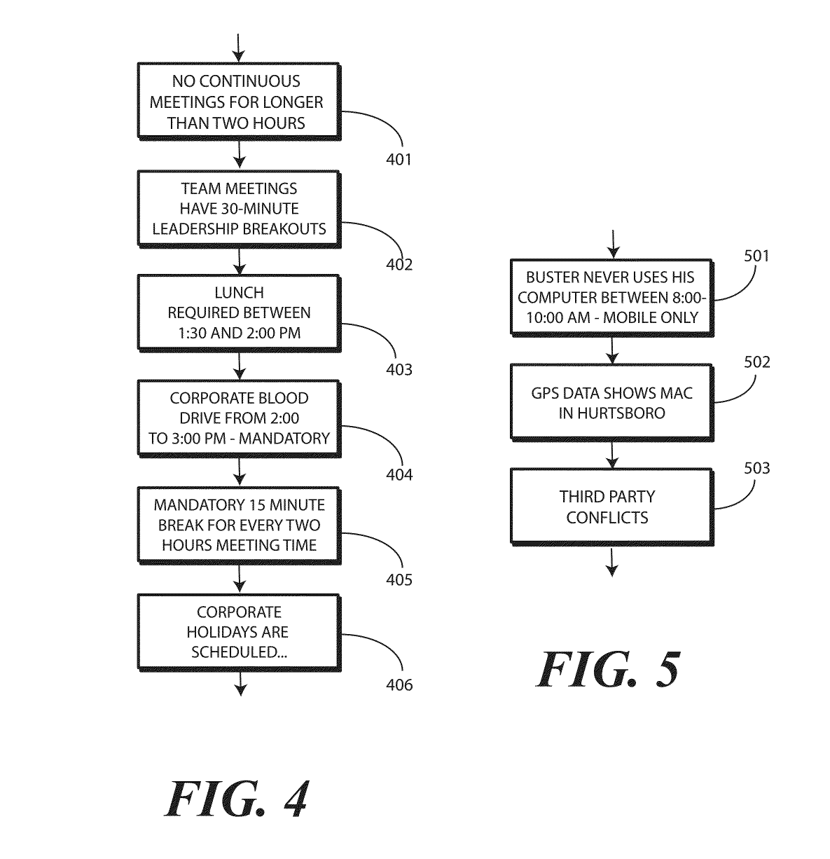

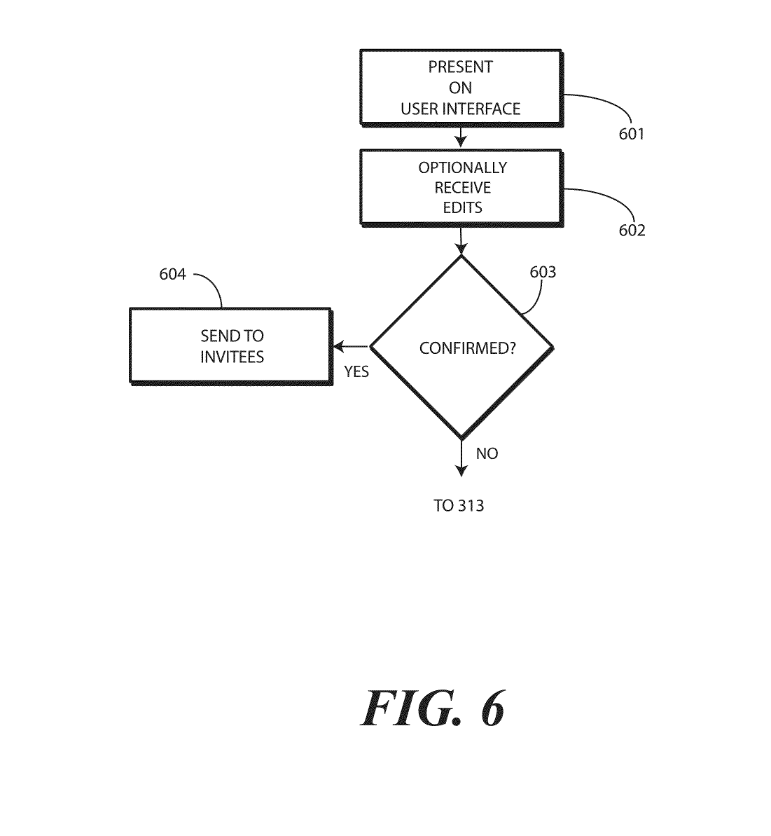

Examples of some of the predefined rules are shown in FIG. 3. For instance, one type of predefined rule can be an interval rule 305. Interval rules may define a minimum meeting length, a maximum meeting length, a maximum continuous meeting duration, and so forth. Another type of predefined rule can be a mandatory break rule 306. The mandatory break rule 306 may describe how frequently breaks must occur, a maximum time span between breaks, a minimum time span between breaks, and so forth. A third type of predefined rule may be a holiday calendar 307. An organization may, for example, publish a holiday calendar 307 listing days on which events are precluded from calendar scheduling. Another type of predefined rule may be that of super-events or sub-events 308. For example, an organization might schedule a charity fundraiser or blood drive or other event that everyone is required to attend. This is an example of a super event. Alternatively, an organization may have a steering committee or other committee that regularly meets at a predefined time. This would constitute a sub-event. These examples are illustrative only. Other predefined rules will be obvious to those of ordinary skill in the art having the benefit of this disclosure. Some of these, and other predefined rules, are presented in FIG. 4. Turning now briefly to FIG. 4, these will be explained.

Predefined rule 401 is an interval rule. In one embodiment, the one or more predefined rules in accordance with which events are to be scheduled comprise a maximum continuous event duration. This particular interval rule states that no continuous meeting can last for more than two hours. Accordingly, a meeting with a desired duration of six hours would need to be fragmented into three sub-meetings.

Predefined rule 402 is a general rule governing meetings. Predefined rule 402 states that any team meeting must have at least one 30-minute leadership breakout session. Thus, to schedule a team meeting in compliance with this predefined rule 402, two sub-meetings would need to be scheduled: a team meeting and a leadership breakout session.

Predefined rule 403 is a mandatory break rule. In one embodiment, the one or more predefined rules in accordance with which events are to be scheduled comprises a predefined meal break. This explanatory predefined rule 403 states that lunch must occur between 1:30 PM and 2:00 PM. Thus, to be in compliance with predefined rule 403, a two-hour meeting scheduled to begin at 12:00 AM would need to be fragmented into two sub-meetings, with a first running from 12:00 AM to 1:30 PM, and a second running from 2:00 PM to 2:30 PM.

Predefined rule 404 provides an example of a super-event. In one embodiment, one or more organizational events can have a priority above a requested event. In such an embodiment, methods can additionally fragment events into the two or more separate sub-events such that the two or more separate sub-events avoid conflict with the one or more organizational events. Super-events are one type of such event.

Illustrating by example, this particular organization has scheduled a corporate blood drive between the hours of 2:00 PM and 3:00 PM. In this illustrative example, employee participation in the corporate blood drive is mandatory. Accordingly, a two-hour meeting to begin at 1:30 PM, to be in compliance with each of predefined rule 401, predefined rule 402, predefined rule 403, and predefined rule 404, would need to being at 3:00 PM and include the leadership breakout session noted above. Accordingly, in one or more embodiments methods and devices are configured to determine another start time in accordance with the one or more predefined rules, where the another start time is different from the requested start time received at step (302) of method (300).

Predefined rule 405 is another mandatory break rule. In one embodiment, the one or more predefined rules in accordance with which events are to be scheduled include a predefined number of breaks per duration of event. This explanatory predefined rule 405 states that every two-hour meeting should include at least one 15-minute break. Thus, a two-hour meeting to begin at 1:30 PM, to be in compliance with each of predefined rule 401, predefined rule 402, predefined rule 403, predefined rule 404, and predefined rule 405 would need to being at 3:00 PM and include three sub-events: a first team meeting before the break, a second team meeting after the break, and the leadership breakout session, which could occur on either side of the break provided the addition of the leadership breakout session duration and the team meeting duration on a common side of the break did not exceed two hours.

Predefined rule 406 is a holiday calendar rule. This predefined rule 406 may preclude, for example, a meeting from being scheduled on Memorial Day. Instead, or in addition to, the holiday schedule, predefined rule 406 can also include workday hours. Thus, in one or more embodiments the one or more predefined rules in accordance with which the events are to be scheduled can comprise predefined working hours.

Turning now back to FIG. 3, in addition to the predefined rules, other information can be received at step 304. Illustrating by example, in one embodiment meeting conflicts 309 pertaining to the attendees can be received so that any subsequent fragmentation occurs around previously scheduled events of the attendees.

Embodiments of the disclosure contemplate that other types of information can be received at step 304 as well. For example, in one embodiment attendee location data 310 can be received. Recall from above that in one or more embodiments, a communication device (100) can include a location sensor (110). One or more communication devices or servers may query the location sensor (110) to determine a location of a communication device belonging to a user. This information can be used in calendar event fragmentation.

Illustrating by a simple example, where a server tracks the location sensor of a communication device, the server may determine that each day person A commutes from home to work between the hours of 8:00 AM and 8:35 AM. Accordingly, where person A is a named attendee at step 303, subsequent fragmentation may occur about this commute time. Other examples of attendee location data 310 suitable for use in fragmentation will be obvious to those of ordinary skill in the art having the benefit of this disclosure.

Additionally, predictive behavior from device usage 311 can be received at step 304. Illustrating by example, it may be known that person B is never “on line” between the hours of 2:00 PM and 3:00 PM. Perhaps this is the time when they pick up their children from school. Since no device activity is detected during this time, subsequent fragmentation may occur about this time window. Other examples of predictive behavior from device usage 311 suitable for use in fragmentation will be obvious to those of ordinary skill in the art having the benefit of this disclosure. Thus, in one or more embodiments the method 300 further comprises determining one or more behavioral patterns by monitoring usage of one or more electronic devices of one or more attendees invited to the meeting request. Subsequent fragmenting can be such that any fragmented sub-meetings are in compliance with the one or more behavioral patterns.

Turning briefly to FIG. 5, illustrated therein are some examples of other information that can be received at step (304) of FIG. 3. Informational component 501 is predictive behavior information. In one or more embodiments, methods and devices can receive one or more behavioral patterns of at least one of the one or more third parties named as attendees in a calendaring event request. The one or more behavioral patterns can comprise usage patterns of one or more third party electronic devices. The one or more behavioral patterns can also comprise geographic location patterns of the one or more third parties that can be received by monitoring a location of one or more third party devices. Accordingly, methods and systems can additionally fragment the calendar event request into two or more separate sub-events such that the two or more separate sub-events avoid conflict with the one or more behavioral patterns of the at least one of the one or more third parties.

In this example, monitoring the communication devices belonging to Buster reveals that

Buster never uses his computer between the hours of 8:00 AM and 10:00 AM. He is available by mobile. However, Buster prefers to use a conventional mobile phone without smartphone capabilities. This is because Buster has his peculiarities. Thus, to be in compliance with informational component 501, an audio conference call could be scheduled between the hours of 8:00 AM and 10:00 AM. However, if the meeting is anything other than an audio conference call it should not be scheduled about this window, as Buster will not be interested in attending.

Informational component 502 is an attendee location component. By monitoring a communication device belonging to Mac, the method (300) identifies that Mac is in the town of Hurtsboro. It is known that Wi-Fi communication is difficult to come by in Hurtsboro. Accordingly, for Mac to be at the meeting, a meeting start time should be delayed until Mac returns from Hurtsboro.

Informational component 503 is a third party conflict component. In one or more embodiments, methods and devices can receive one or more conflicting events scheduled by one or more third parties named as attendees of a calendar event request. Methods and devices can thus additionally fragment the calendar event request into two or more separate sub-events such that the two or more separate sub-events avoid conflict with the one or more conflicting events.

Illustrating by example, presume Mac and Buster like to play golf on Friday mornings and routinely have this time booked on their calendar. To be in compliance with this component, meetings listing either Buster or Mac as attendees should not be scheduled on Friday mornings, as neither will be in attendance.

Turning now back to FIG. 3, once the organizational policies 204 and, optionally, other information is received at step 304, the method 300 can determine whether the calendaring event request can be created—in accordance with the organizational policies 204 and/or other information—as a single event at decision 312. Where it can, the event can be calendared at step 313 as a single, continuous event.

Where it cannot, due to conflicts with one or more of the organizational policies 204 or other information, in one embodiment, the method 300 fragments the calendaring event request at step 314 into two or more sub-events such that the two or more sub-events are in compliance with one or more of the organizational policies 204 governing meetings or other information. Where, for example, the calendaring event request received at step 302 is a meeting request, step 314 can include fragmenting the meeting request into two or more sub-meetings such that the two or more sub-meetings are in compliance, i.e., do not conflict with, the one or more organizational policies 204 governing meetings, or optionally the other information received at step 304. In one embodiment, step 314 occurs automatically. In one embodiment, step 304 is performed by one or more processors of an electronic device. The one or more processors can be in a server, in a communication device, or combinations thereof. Whether the event has been successfully fragmented is checked at decision 315.

In one embodiment, as shown at optional step 316, the method can further comprise creating one or more reminders. Said differently, in one embodiment the method 300 can automatically generate one or more reminders for each of the two or more separate sub-events in accordance with the one or more predefined rules. In one embodiment, at least one reminder corresponds to each sub-meeting of the two or more sub-meetings created at step 314. For example, if the calendar event request received at step 302 is fragmented at step 314 into three sub-meetings with one break, a reminder can be set for each sub-meeting and the break. In one embodiment, step 316 occurs automatically. For example, one or more processors of a communication device, or alternatively as server, can automatically add these reminders at step 316.

At step 317, additional operations can occur. Once the additional operations occur, in on embodiment step 313 then comprises, optionally upon receiving confirmation, calendaring two or more separate sub-events in accordance with the one or more predefined rules and delivering an

In one embodiment, methods and devices can present, on a user interface, the two or more separately fragmented sub-events in accordance with the one or more predefined rules. For example, at step 601, an additional operation in the form of presenting the fragmented meeting to a user on a user interface of an electronic device can occur. This step 601 allows the user to review how the meeting has been fragmented. Where the fragmentation is acceptable and is confirmed in response to the presenting two or more separate sub-events in accordance with the one or more predefined rules for confirmation at step 601, as determined at decision 603, the fragmented event can be delivered to invitees at step 604.

In one embodiment, methods and devices can further receive one or more user edits to the two or more separately fragmented sub-events in accordance with the one or more predefined rules. For example, where the fragmentation is not optimal for some reason, at optional step 602 user edits can be received. For example, user edits to alter at least one of a start time, a duration, or an end time of the two or more sub-meetings created by the fragmentation of step (314) of method (300) can be received. Once the modified fragmentation is acceptable and is confirmed, as determined at decision 603, the fragmented event can be delivered to invitees at step 604.

Turning now to FIGS. 7-12, illustrated therein are explanatory method steps by which a user employs a communication device configured in accordance with one or more embodiments of the disclosure to automatically fragment a calendar event request into two or more sub-events in accordance with one or more organizational policies and/or other information.

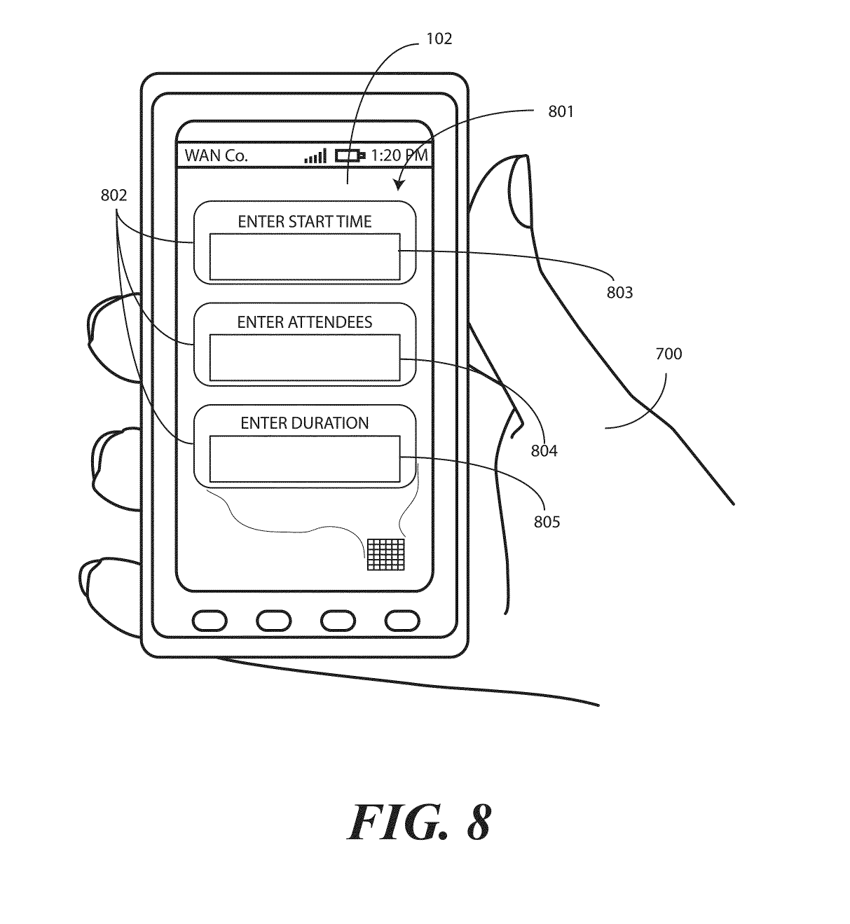

Beginning with FIG. 7, a user 700 is holding the communication device 100. The user 700 initially actuates 701 a calendaring application 115 operating on one or more processors (103) of the communication device. As shown in FIG. 8, a user interface 801 to receive a calendaring event request 802 is presented on a display 102 of the communication device 100. Accordingly, one or more processors (103) of the communication device 100 receive, at FIG. 8, the calendaring event request 802. In this embodiment, the calendaring event request 802 comprises a multi-party event.

In this illustrative example, the calendaring event request 802 comprises only three items:

a requested start time 803, one or more third parties 804 who will be invited as attendees, and a duration 805. It should be noted that other information could be entered as well if desired. Recall from above that our friend, Buster, only uses a conventional mobile phone with voice communication capabilities between the hours of 8:00 AM and 10:00 AM. Additionally recall that Mac is in Hurtsboro where WiFi or other data communication capabilities are either unavailable, or are too slow to accommodate video conferencing needs Accordingly, the user 700 may want to selectively provide an indication that presentation slides will be shown in the calendaring event request of FIG. 8. This is perfectly fine, as embodiments of the disclosure can provide for special requests in addition to the requested start time 803, the one or more third parties 804 who will be invited as attendees, and the duration 805. However, in one or more embodiments designed for streamlined use, the user 700 needs to only enter three items: the requested start time 803, one or more third parties 804 who will be invited as attendees, and the duration 805.

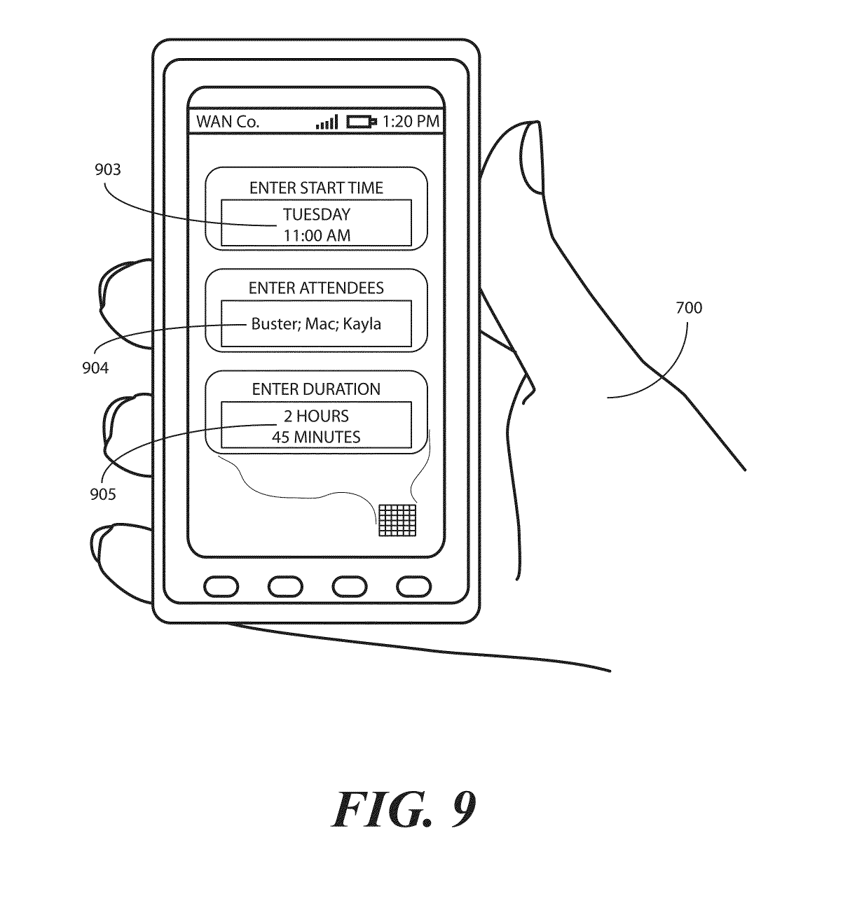

Turning to FIG. 9, the user 700 has entered a start time 901 of 11:00 AM on Tuesday. The user 700 has also entered a list of attendees 904, which include Buster, Mac, and Kayla. The user 700 has also entered a duration 905, which in this example is two hours and forty-five minutes.

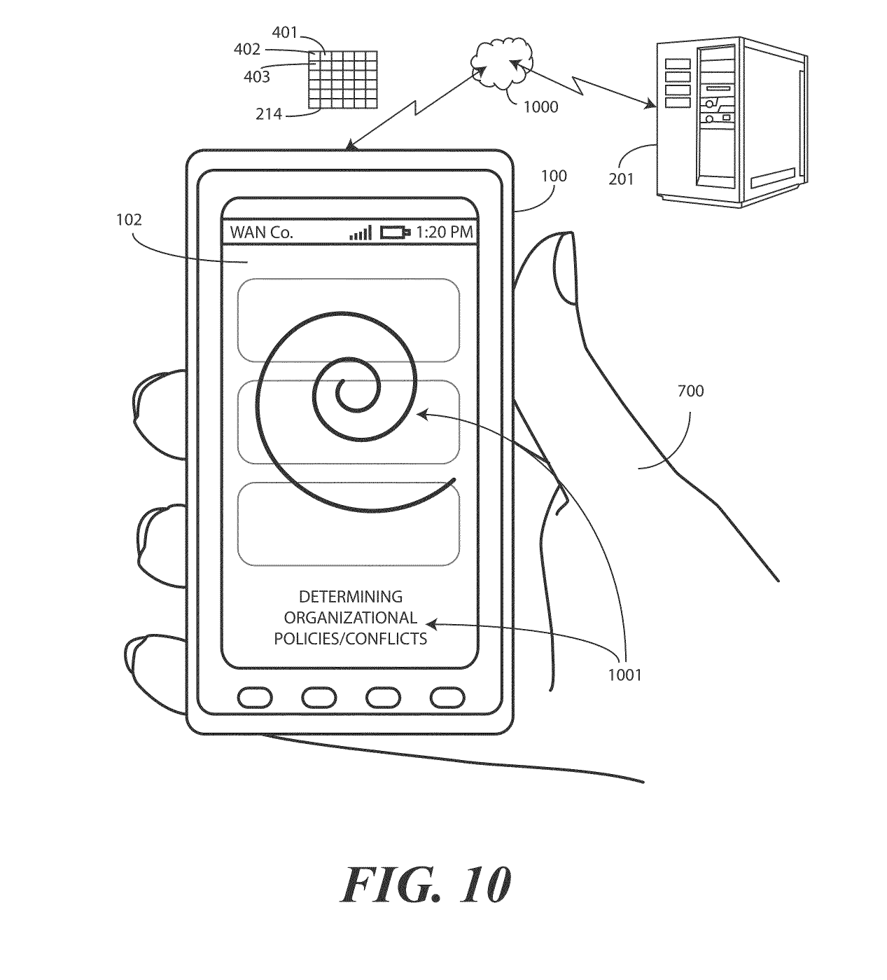

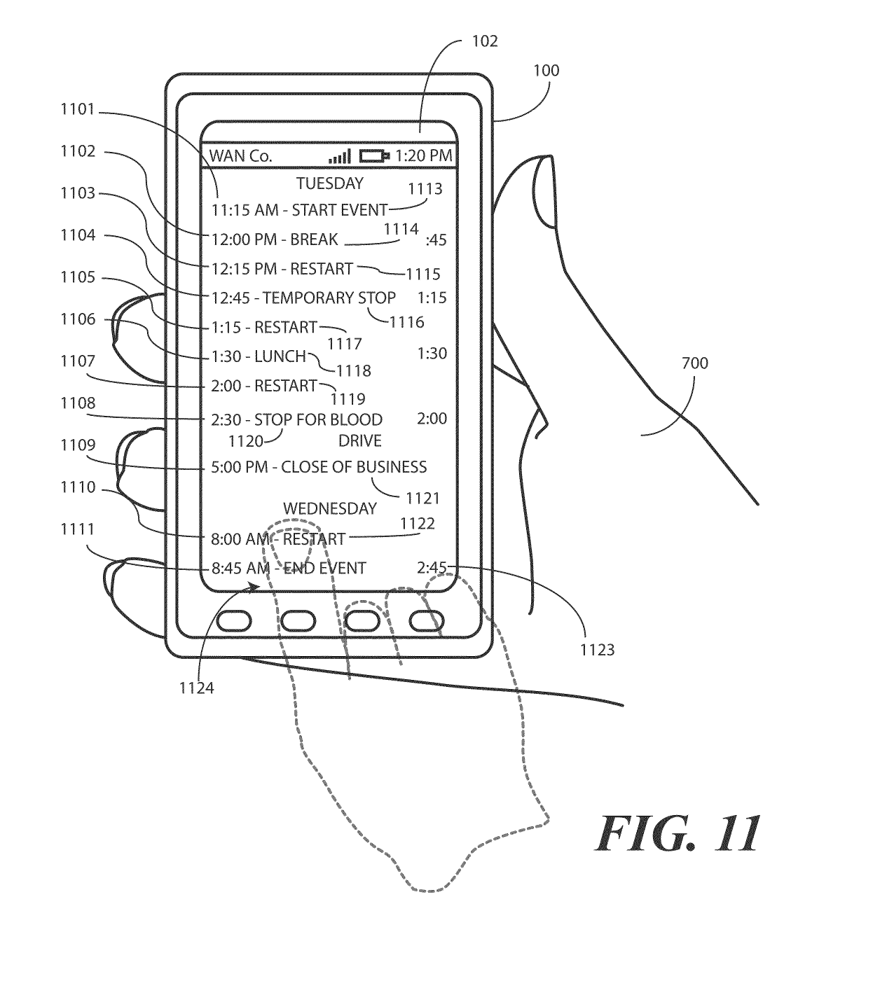

In FIG. 10, one or more processors (103) of the communication device 100 communicate with a server 201 across a network 1000 to retrieve one or more organizational policies 204 defining one or more predefined rules 401,402,403 in accordance with which events are to be scheduled. The one or more processors (103) present an indication 1001 to the user 700 on the display 102 of the communication device 100 that background processing is occurring. Once these predefined rules 401,402,403 are received, one of the communication device 100, the server 201, or combinations thereof can fragment the calendaring event request (802) into one or more separate sub-events in accordance with the one or more predefined rules 401,402,403. This has been done in FIG. 10, with the results shown on the display 102 of the communication device 100.

Turning now to FIG. 10, two or more separate sub-events 1101,1102,1103,1104,1105,1106,1107,1108,1109,1110,1111 are presented on the display 102 of the communication device 100 for confirmation by the user 700. Recall from FIG. 9 that the start time (903) was desired to be 11:00 AM on Tuesday. However, in response to the one or more predefined rules (401,402,403), in this embodiment the one or more processors (103) of the communication device 100 determined another start time 1112, i.e., 11:15 AM, that was different from the requested start time (903) of 11:00 AM.

The first sub-event 1101 is a sub-meeting 1113 that lasts for forty-five minutes. A required break 1114 then has been fragmented into the calendaring event request (802). After the break 1114, the next sub-event 1103 comprises a second sub-meeting 1115 that begins at 12:15 PM. Due to an attendee conflict 1116, the second sub-meeting 1115 stops at 12:45 PM.

The next sub-event 1106 comprises a third sub-meeting 1117 that commences at 1:15 PM. However, a mandatory lunch break 1118 occurs at 1:30 PM. The next sub-event 1107 is a fourth sub-meeting 1119 beginning at 2:00 PM. A super-event 1120 then occurs. In this illustrative example, the super-event 1120 is a blood drive that will last the remainder of the work day, i.e., two and a half hours. The super-event 1120 is followed by a predefined working hour 1121 limitation. Accordingly, the next sub-event 1110 is a fifth sub-meeting 1122 starting at 8:00 AM on Wednesday. The calendaring event request (802) finally ends at 8:45 AM.

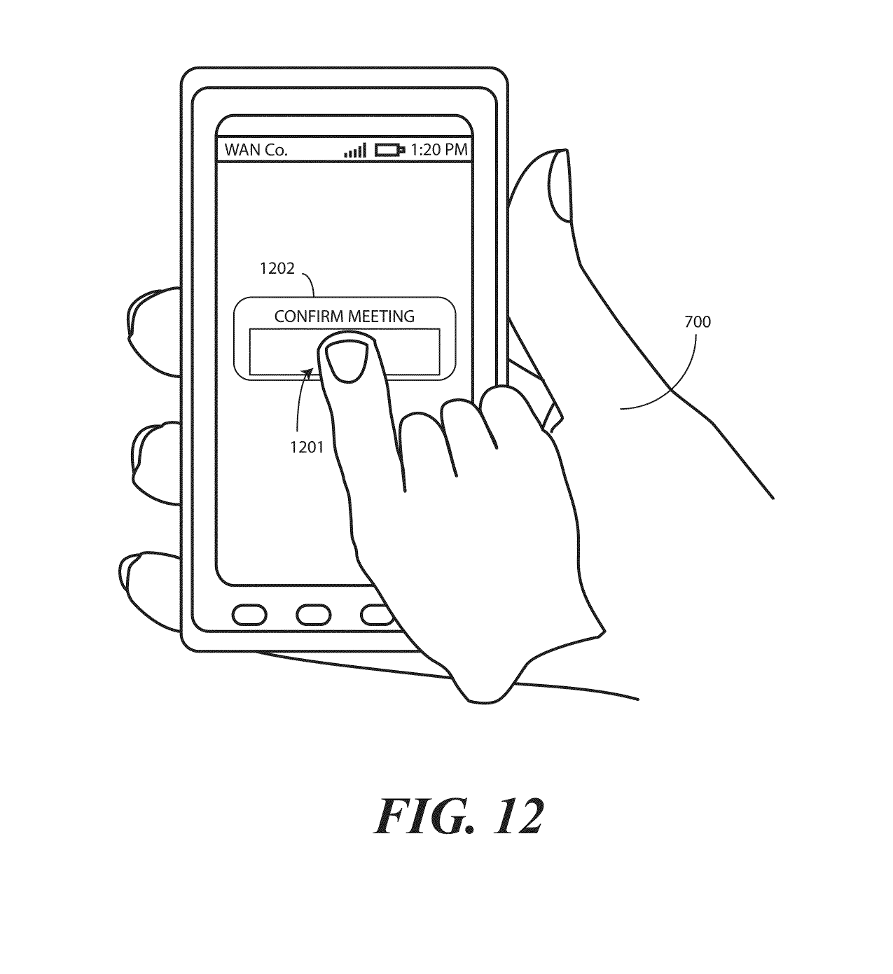

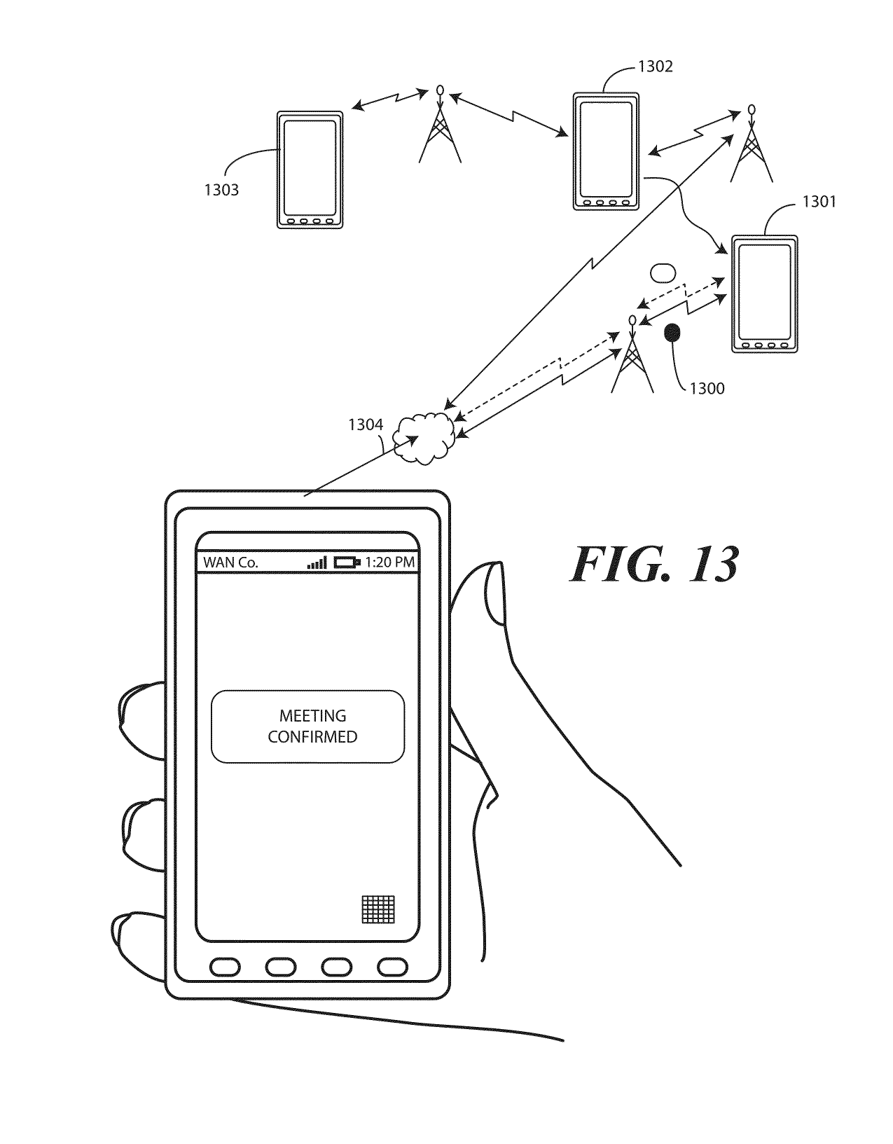

Indications of time 1123 for each sub-event can optionally be presented on the display 102 of the communication device 100. Additionally, as noted above, the user 700 can edit 1124 the two or more separate sub-events 1101,1102,1103,1104,1105,1106,1107,1108,1109,1110,1111 as necessary. At FIG. 12 the user 700 confirms the fragmented calendar event 1200. At FIG. 13, an invitation 1300 can be delivered (1304) to one or more third parties 1301,1032,1303. In one embodiment, the invitation 1300 includes the two or more separate sub-events 1101,1102,1103,1104,1105,1106,1107,1108,1109,1110,1111.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A communication device, comprising:
a user interface;
a communication circuit;
one or more processors operable with the user interface and the communication circuit; and
one or more memory devices to store one or more applications operable on the one or more processors;
the one or more processors to:
receive, with the user interface, a calendaring event request for a multi-party event;
receive, with the communication circuit, one or more organizational policies defining one or more predefined rules in accordance with which multi-party events are to be scheduled; and
automatically fragment the multi-party event into two or more separate sub-events in accordance with the one or more predefined rules.

2. The communication device of claim 1, the one or more predefined rules in accordance with which the multi-party events are to be scheduled comprising a predefined number of breaks per duration of event.

3. The communication device of claim 1, the one or more predefined rules in accordance with which the multi-party events are to be scheduled comprising a predefined meal break.

4. The communication device of claim 1, the one or more predefined rules in accordance with which the multi-party events are to be scheduled comprising predefined working hours.

5. The communication circuit of claim 1, the one or more predefined rules in accordance with which the multi-party events are to be scheduled comprising a maximum continuous event duration.

6. The communication device of claim 1, the one or more processors further to:
receive, with the communication circuit, one or more organizational events having a priority above the multi-party event; and
additionally automatically fragment the multi-party event into the two or more separate sub-events such that the two or more separate sub-events avoid conflict with the one or more organizational events.

7. The communication device of claim 1, the calendaring event request comprising only:
a requested start time;
one or more third parties; and
a duration.

8. The communication device of claim 7, the one or more processors to:
receive, with the communication circuit, one or more conflicting events scheduled by the one or more third parties; and
additionally automatically fragment the multi-party event into the two or more separate sub-events such that the two or more separate sub-events avoid conflict with the one or more conflicting events.

9. The communication device of claim 7, the one or more processors to:
receive, with the communication circuit, one or more behavioral patterns of at least one of the one or more third parties; and
additionally automatically fragment the multi-party event into the two or more separate sub-events such that the two or more separate sub-events avoid conflict with the one or more behavioral patterns of the at least one of the one or more third parties.

10. The communication device of claim 9, the one or more behavioral patterns comprising usage patterns of one or more third party electronic devices.

11. The communication device of claim 9, the one or more behavioral patterns comprising geographic location patterns of the one or more third parties, the geographic location patterns received by monitoring a location of one or more third party devices.

12. The communication device of claim 7, the one or more processors further to determine another start time in accordance with the one or more predefined rules, the another start time different from the requested start time.

13. The communication device of claim 1, the one or more processors to automatically generate one or more reminders for each of the two or more separate sub-events in accordance with the one or more predefined rules.

14. The communication device of claim 1, the one or more processors to:
present, on the user interface, the two or more separate sub-events in accordance with the one or more predefined rules; and
receive, with the user interface, one or more user edits to the two or more separate sub-events in accordance with the one or more predefined rules.

15. The communication device of claim 1, the one or more processors to:
present, on the user interface, the two or more separate sub-events in accordance with the one or more predefined rules for confirmation; and
upon receiving confirmation, calendar the two or more separate sub-events in accordance with the one or more predefined rules and deliver an invitation to the multi-party event to one or more third parties, the invitation comprising the two or more separate sub-events in accordance with the one or more predefined rules.

16. A method in an electronic device, the method comprising:
receiving, with a user interface of the electronic device, a meeting request;
receiving, with one or more processors of the electronic device, one or more organizational policies governing meetings of an organization; and
automatically, with the one or more processors of the electronic device, fragmenting the meeting request into two or more sub-meetings such that the two or more sub-meetings are in compliance with the one or more organizational policies governing meetings.

17. The method of claim 16, the meeting request consisting essentially of a start time, an attendee list, and a meeting duration.

18. The method of claim 16, further comprising receiving, with the user interface of the electronic device, user edits to alter at least one of a start time, a duration, or an end time of the two or more sub-meetings.

19. The method of claim 16, further comprising automatically, with the one or more processors, creating one or more reminders, with at least one reminder corresponding to each sub-meeting of the two or more sub-meetings.

20. The method of claim 16, further comprising, determining, with the one or more processors, one or more behavioral patterns by monitoring usage of one or more electronic devices of one or more attendees invited to the meeting request, the fragmenting further such that the two or more sub-meetings are in compliance with the one or more behavioral patterns.
